(19) United States
(12) Patent Application Publication
(10) Pub. No.: US 2004/0075033 A1
(43) Pub. Date: Apr. 22, 2004

(54) Dryer holder

(76) Inventor: Sumiko Fujitaka, New York, NY (US)

Correspondence Address: Sumiko Fujitaka, 5-23-6, Hongo, Bunkyo-ku, Tokyo, 113-0033, JP

(21) Appl. No.: 10/395,617

(22) Filed: Mar. 24, 2003

Related U.S. Application Data
(60) Provisional application No. 60/419,894, filed on Oct. 21, 2002.

(51) Int. Cl. E04G 3/00; F26B 19/00

(52) U.S. Cl. 248/274.1; 34/90; 34/97

(57) ABSTRACT

A hand-free and simply adjustable maneuver hair dryer holder is provided. The Hair dryer holder contains a clip body system, an arm, and a support base. The Clip body system includes a couple clip bodies, a pin, and a coil spring. Movement of a couple ears on the coupled clip bodies arranges the arch of a barrel of the hair dryer. The arm is extensible and flexible. And also the arm is one touch system to hook in and out. This provides the operator more convenient because the clip system may be adaptable to variety type of the hair dryers.

### BACKGROUND OF THE INVENTION

The present invention relates generally to an engaging arrangement for hair dryer that allows the hair dryer holder to be assembled easily and self-support for a hair dryer more conveniently flexible.

### Discussion

Conventional hand held hair dryers for use in home assume the shape of gun. While an operator is using a hair dryer to dry or style his or her hair, constantly the hair dryer is positioned by one of his or her hand until the operation is done. At time, the operator may desire one extra hand to hold the dryer from convenient position while using the hair dryer to dry or style his or her hair.

The present prior art approached for operating the hair dryer in a hands-free mode through the use of hair dryer supports. Many of these supports are still brought with inconvenience. For some example, some hair dryer supports require hair dryers specifically adapted for attachment to, or insertion into the supports. Or some supports, the hair dryer must be fastened into the supports in order to have a secured stabilizing. Once the hair dryer is fastened with those supports, it is not easier to remove the hair dryer out from those supports. When the operator needs to brow air on the counter top to dust away, to change a place to another place, or some other purposes, the operator may feel inconvenience to fasten the hair dryer into those supports.

Conventional hair dryer barrels shape in many way of cylindrical, such as straight, narrow in the tip and wide in the end, oval diameter, long or short, or ion mount under the barrel. Some types of cylindrical prior arts hold the hair dryer barrel. This type of ring is able to fasten tightly only the specifically adapted hair dryer barrel.

Further yet, stand type hair dryer supports have a rather large or heavy base that these sit on the floor, the desk, or the table. These supports have to bring up the hair dryer in convenience position. This stand type may be too bulky when the dryer weight more heavy. In addition, many stands interrupt the hair drying operation. That is when the operator wants to change air blowing direction that the operator may need to stop the drying operation and use one hand to hold the support and the other hand to change the dryer's direction because of preventing the dryer and the support falling.

Further yet, there may be only limited flexibility of the height in the prior arts. The multiple users in a unit, the each operator may need to adjust the support height each time. Present prior arts may be not simple adjustment for the height.

Thus, there is a need for a hair dryer support, which is portable, adaptable to variety type of dryer shapes, each user's needs, and which enables substantial variation in the orientation of hair dryer.

### SUMMARY OF INVENTION

The improved hair dryer and holder assembly of the present invention satisfies all of the foregoing needs. The hair dryer holder includes a clip system; slightly adjustable a clip head including two clip bodies, a coil spring, and a pin to connect the two clip bodies with the coil spring in the center, the clip head engaging to an arm; telescopically extensible part and flexibly bendable part. The extensible part includes an inner tube and an outer tube. The flexible part interconnects to the outer tube and a flat base. The flat base may be shaped a nail head or letter T to be hooked. The flat or T shaped base may be hooked to a separate support base. The separate support base may be shaped or sized variously. The dryer holder may be made of metal materials and rubber or resin material may partially be used for layer courting.

To the accomplishment of the above and related objects, this invention may be embodied in the form illustrated in the accompanying drawings and subjoined claims, other objects and advantages of the present invention will become apparent to those skilled in the art.

### OBJECTS OF INVENTION

Therefore, it is an object of the present invention to provide a hair dryer holder having a holding system that is adaptable to hair dryer of various shapes and size.

It is further object of the present invention to provide this dryer holder having an arm; which is moderately, simple adjust, extensible, and flexible.

And the holder is secured in any desired places and also simply removable to change other desired areas.

It is still further object of this invention to provide a relatively compact, portable and less cost to manufactures and reasonable price to consumers.

### DESCRIPTION OF THE PREFERRED EMBODIMENTS

Description of the preferred embodiments of the dryer holder of the present invention is illustrated in FIGS. 1-9.

Holder has a clip body system, an arm portion, a base, and support base as the conventional hair dryer supports and the main different structure is the clip body system.

The clip body system, as shown FIGS. 1, 2, 3, has two clip bodies; A type 20 and B type 26, a pin 34, and a coil spring 36. The clip bodies A 20 and B 26 have two ears 22, 28 each extending from extended area 20b, 26b of the clip bodies 20, 26. Four of the ears 22a, 22b, 28a, and 28b have one uneven passenger hole 24, 32. The pin 34 and the coil spring 36 are inserted through the four holes 24a, 24b, 32a, 32b of the ear 22 and 28 of the clip bodies A 20 and B 26.

Pivotally placed the pin 34 is combining the clip bodies 20, 26 and the coil spring 36 forcing to close the clip bodies A, 20 and B, 26 inwardly. The conventional hair dryer 10 is adapted in the clip body system's movement, as shown in the FIGS. 4-5. One side of the pin 34 widely opens through by the unevenly opened four passenger holes 24a 24b, 32a 32b. The two ears 22a, 22b of the B type clip body 26 are slightly curved. An additional tape may be placed on barrel of the hair dryer 10 to prevent the dryer 10 falling off from the clip bodies 20 and 26.

The extended area 26b of B type body 26, as shown in FIG. 3 and FIG. 4, may be longer than the A type 20b. The tip of extended area 26b of the B type clip body 26 connects with an engagement member 38 by a joint pin 46 through joint holes 40, as shown in FIG. 7, the engagement member 38 attaches an inner tube 52 by a cover 48 with rotation pin rolls 54. The engagement member 38 is inserted through a hole 50 of the cover 48. The cover 48 is screwed on the inner tube 52 and may be finished by welding. The arm is having an extensible part 52, 62 and a flexible part 68 as shown in FIG. 6. The extensible part includes an inner tube 52 and an outer tube 62. The engagement member 38 is allowed to rotate inside of the inner tube 52. Rotation of the engagement member 38 is guided by a groove 44 around the engagement member 38 and a couple of rotation roll pins 54 in the open spaces 56 on the inner tube 52, as shown in FIGS. 7-8. The telescopically extensible inner tube 52 has a stopper 60 and the outer tube 62 has a couple of length adjustable stopper holes 64. The inner tube 52 and the outer tube 62 are extended by guide groove 58 and 66. One side of flexible part 68 interconnects to the outer tube 62 and the other end interconnects to a base 72. The base 72 shapes flat or like a letter T or may shape in variety. The base 72 may be hooked in a support base 74 mounted on the places like the wall or the counter. And once the base 72 is inserted into the support base 74, the pushed or screwed type stopper 70 may be tightened against to the support base 74. Or the base 72 may be rocked into the mounted support base 74.

As can be understood from the above description, the clip body system and the extensible and flexible arm combined by the engagement member in this invention has advantages as follows:

1. The clip body system in this invention has a self adjust angle by sliding the pin, which is inserted in the ear of clip bodies, holding system of the clip body is adaptable to variety type of hair dryers.

2. The arm and the support base are separated which the operator is able to change the dryer holder by one-hand operation to another desired place in needs.

### BRIEF DESCRIPTION OF DRAWINGS

The invention will be better understood by reference to the accompanying drawing, where in;

FIG. 1 is a perspective view of the assembled dryer holder with a conventional hair dryer holding position.

FIG. 2 is a perspective view of the partially assembled dryer holder clip and the arm showing with T shaped base.

FIG. 3 is a fragmentary perspective view of the clip body system showing a couple of clip bodies are slightly different.

FIG. 4 is an enlarged perspective view of the clip system detail.

FIG. 5 is an enlarged detail of the pin and the clip bodies movement as indicated by arrows C-C′ in FIG. 4.

FIG. 6 is a side elevational view of the arm part.

FIG. 7 is an enlarged side elevational fragment view of the engagement member's joint.

FIG. 8 is an enlarged perspective view of the assembled engagement member's joint with parts broken away.

FIG. 9 is a perspective view of the base area showing the base hooked on the support base.

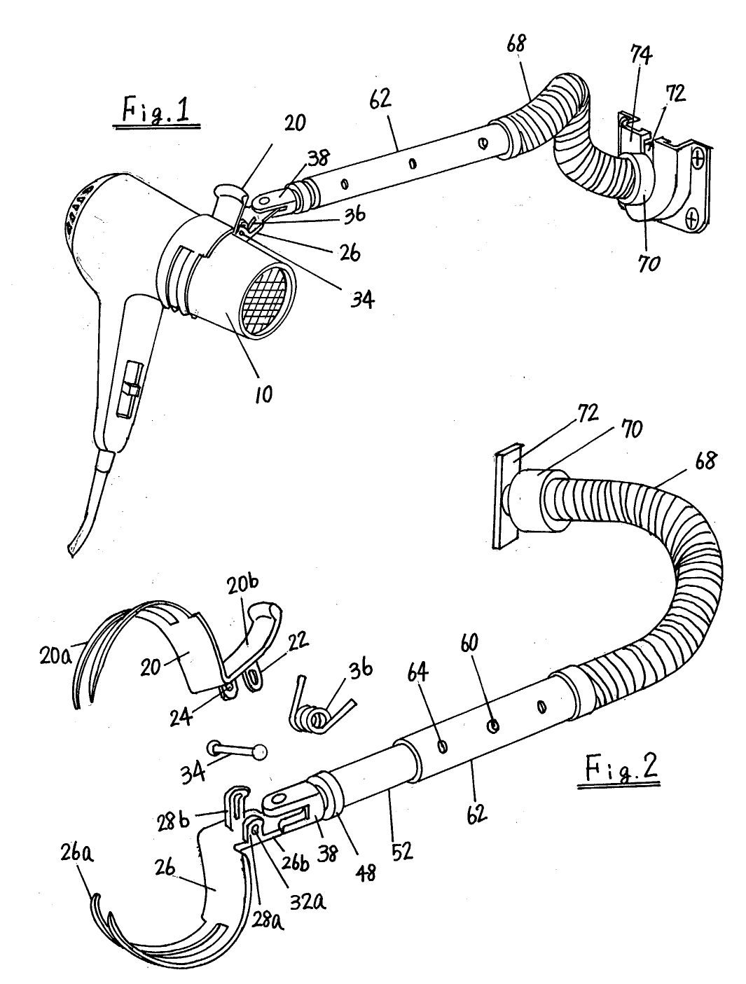

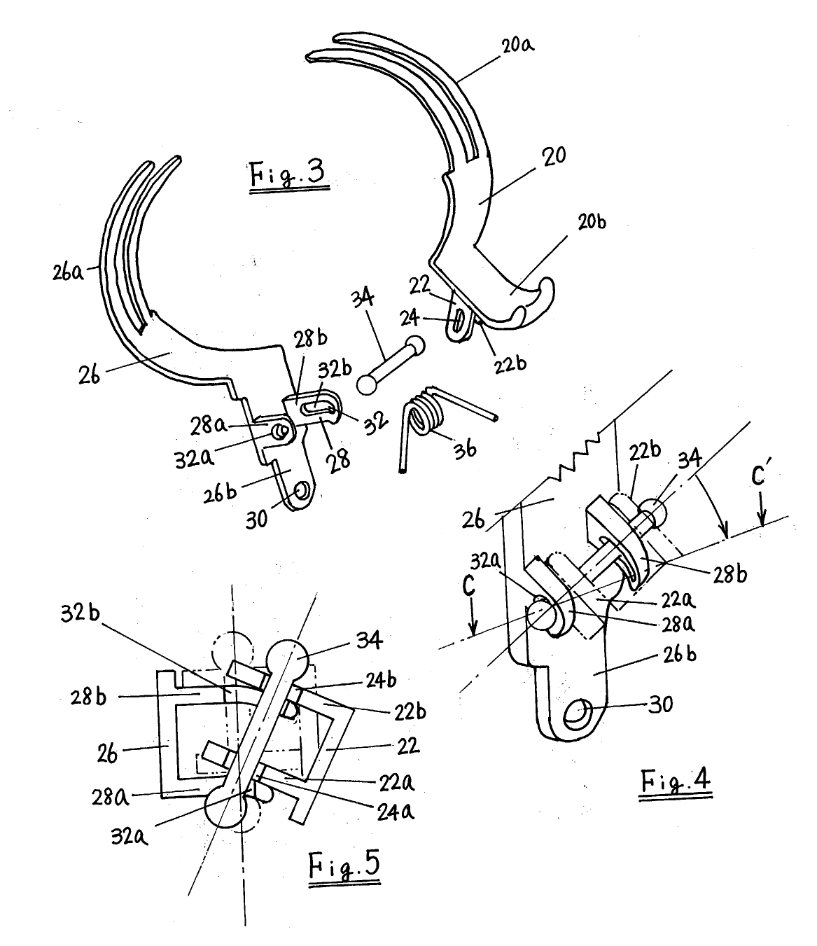

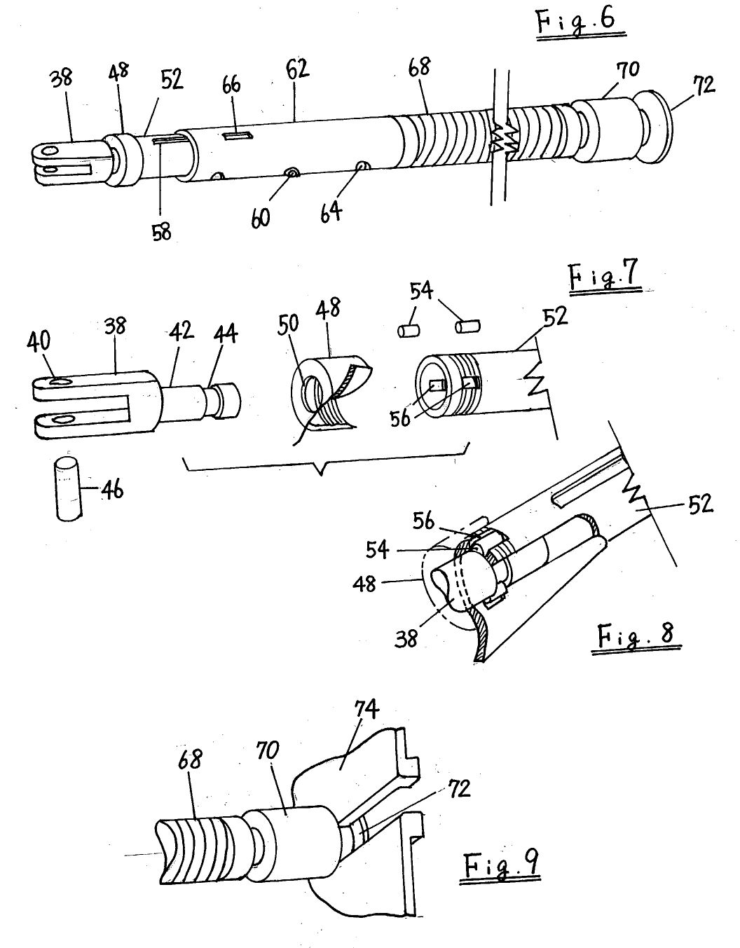

LIST OF REFERENCE NUMBERS:
10 Hair Dryer
20 A type clip body; 20a A type clip body
tine, 20b A type clip body bottom
22 Ear of 20; 22b, 22b
24 Hole of 22; 24a, 24b
26 B type clip body; 26a B type clip body
tine, 26b B type clip body bottom
28 Ear of 26; 28a, 28b
30 Joint hole of 26
32 Hole of 28; 32a, 32b
34 Pin
36 Spring Coil
38 Engagement member
40 Joint hole of 38
42 Shaft of 38
44 Groove of 38
46 Joint pin through 40 and 30
48 Cover
50 Hole of 48
52 Inner tube
54 Rotation roll pins to 56 and 44
56 Open space for 54
58 Guide groove of 52
60 Stopper of 52
62 Outer tube
64 Stopper holes of 62
66 Guide groove of 62
68 Flexible part (Goose Neck)
70 Stopper or screw
72 Base
74 Support base

1. A Dryer Holder comprising:
A clip system having a plurality of clip bodies, a pin, a coil spring, each said clip body having a jaw portion and back portion, said back portion having a plurality of protruded members, each of said protruded member having an uneven passage hole, said pin and said coil spring are pivotally inserted into said passage holes of said protruded members of said clip bodies, a pair of said jaws is formed annularly, one of said back portion of said clip body is a straight end and other is a curved end, wherein pressing down of said curved end retained said jaw portion open widely,
An arm having an extensible part and a flexible part, an inner tube of said extensible part telescopically extends from an outer tube, said inner tube having a trust button and said outer tube having a plurality stopper holes, the one end of said extensible part attached to an engagement member, the other end of said engagement member attached to said straight end of said clip bodies; said engagement member rotates and angles said clip body system, the other end of said extensible part interconnects to said flexible part; extensible and flexible movement of said arm positions a hair dryer conveniently while the operator is using said hair dryer,
A flat base interconnecting to the other end of said flexible part,
A support base is securely stabilized on any desired surface area, said support base having an aperture from an opening side to center to receive said flat base,

2. The dryer holder stand of claim 1 wherein said jaw portion may be formed a couple of tines in a tip area,

3. The dryer holder stand of claim 2 wherein said tines alternately line up when said spring biasing said jaw portions together,

4. The dryer holder stand of claim 1 wherein said pin slightly moves farther wide on one side than others,

5. The dryer holder stand of claim 1 wherein said engagement member connecting to said inner tube by a plurality of cylindrical pins on the sides,

6. The dryer holder stand of claim 5 wherein said a plurality of cylindrical pins rotates said engagement member,

7. The dryer holder stand of claim 1 wherein said flat base may be formed a nail head or letter T shape,

8. The dryer holder stand of claim 7 wherein said flat base is inserted into said aperture of said a support base,

9. The dryer holder stand of claim 7 wherein said flat base may be tightened by a stopper which may be screwed or pushed against said support base, or said flat base inserted into socket type of said support base,
Whereby said present improved dryer holder retains various type of said hair dryer with convenient position in desired area to provide the operator to use their both hands freely.
